(19) United States
(12) Patent Application Publication
(10) Pub. No.: US 2017/0102310 A1
(43) Pub. Date: Apr. 13, 2017

(54) FLOW CYTOMETER AND A MULTI-DIMENSIONAL DATA CLASSIFICATION METHOD AND AN APPARATUS THEREOF

(71) Applicants: SHENZHEN MINDRAY BIO-MEDICAL ELECTRONICS CO., LTD., Shenzhen (CN); BEIJING SHEN MINDRAY MEDICAL ELECTRONICS TECHNOLOGY RESEARCH INSTITUTE CO., LTD., Beijing (CN)

(72) Inventors: Yan XU, Beijing (CN); Cheng QIAN, Beijing (CN); Xin LI, Beijing (CN); Junbin XIE, Shenzhen (CN)

(21) Appl. No.: 15/295,891

(22) Filed: Oct. 17, 2016

Related U.S. Application Data
(63) Continuation of application No. PCT/CN2014/075613, filed on Apr. 17, 2014.

(51) Int. Cl. G01N 15/06; G01N 15/14

(52) U.S. Cl. CPC G01N 15/06; G01N 15/1429; G01N 2015/0693

(57) ABSTRACT

The present disclosure provides a flow cytometer and a multidimensional data automatic classification method and apparatus thereof. An auxiliary parameters and a main parameter are selected for a target cell population of each detection item. A statistical analysis is first performed on particle characteristic data of cells according to the auxiliary parameters to obtain a cell population of interest. Another statistical analysis is then performed on the particle characteristic data according to the main parameter. Afterwards, the cell population of interest is mapped to a statistical result obtained in the statistical analysis performed according to the main parameter; and finally, the target cell population is obtained according to a distribution position and an edge of the-cell population of interest as well as a gating on the main parameter.

### FIELD OF TECHNOLOGY

The present disclosure relates to cell analysis, and in particular to flow cytometers and multidimensional data classification methods and apparatus thereof.

### BACKGROUND

Flow cytometer analyzes and identifies cells by receiving a variety of optical signals from the cells in a stream after laser irradiation. Flow cytometry optical signals usually include forward scatter light (FSC), side scatter light (SSC) and various fluorescence (FL1, FL2 . . . ), and these signals form different parameters, different channels or different dimensions of flow cytometry data. These optical signals can reflect physical and chemical characteristics of the cells or particles, such as their size, granularity and labeled fluorescein.

The flow cytometer may collect the optical signals by each channel and perform cell analysis by gating. The gating may refers to specify and analyze a range of target cell population in certain dimensions. Manual gating is based on subjective judgments, and different people may make different results, which is difficult to achieve consistent results. Computer technology facilitates the data analysis of the flow cytometry. For many clinical flow cytometry test items, commercial vendors offer automatic gating functions, which are significantly advantageous to not only reduce the workload of people, but also reduce the error caused by the subjective judgment during manual gating, thereby improving the consistency of analysis results. Another advantage of the automatic gating is that it can analyze multiple parameters at the same time to get more information to improve the accuracy of the gating.

However, both the automatic gating and the manual gating are commonly difficult to be determined accurately when some cell populations are distributed to overlap with each other or when the target cell population cannot be easily determined. For example, when classifying the range of the cell populations, a large number of interference cells are present in the classified cell populations, or interference cells are close to the target cell population, which may interfere the gating. On the other hand, the location of each cell population in a dot plot may deviate from its expected location due to changes in instrument settings such as voltage or compensation, changes in antibody concentration in a reagent, abnormal blood samples, or errors in sample preparation operations.

### SUMMARY

According to a first aspect of the present disclosure, the present disclosure provides an automatic classification method for flow cytometry multidimensional data, including: acquiring particle characteristic data for characterizing cell particles, where the particle characteristic data is a data set collected by a plurality of channels of a flow cytometer; determining at least one auxiliary parameter according to a test item of the flow cytometer, where each auxiliary parameter refers to one dimension of the particle characteristic data; performing a statistical analysis on the particle characteristic data according to the auxiliary parameter; extracting a cell population of interest from a statistical result of the analysis performed according to the auxiliary parameter; performing another statistical analysis on the particle characteristic data according to a main parameter, where the main parameter is a parameter by which a target cell population is enclosed through gating from a statistical result obtained said parameter, and the main parameter refers to at least another dimension of the particle characteristic data that is different from the auxiliary parameter; mapping the extracted cell population of interest onto a statistical result of the analysis performed according to the main parameter; and determining the target cell population by using a distribution location and an edge of the cell population of interest and by incorporating a gating on the main parameter.

According to a second aspect of the present disclosure, the present disclosure provides an automatic classification apparatus for flow cytometry multidimensional data, including: a data acquisition unit for acquiring particle characteristic data used to characterize cell particles, where the particle characteristic data is a data set collected by a plurality of channels of a flow cytometer; an auxiliary parameter determination unit for determining at least one auxiliary parameter according to a test item of the flow cytometer, where each auxiliary parameter refers to one dimension of the particle characteristic data; an auxiliary parameter statistical unit for performing a statistical analysis on the particle characteristic data according to the auxiliary parameter; a first extraction unit for extracting a cell population of interest from a statistical result of the analysis performed according to the auxiliary parameter; a main parameter statistical unit for performing another statistical analysis on the particle characteristic data according to a main parameter, where the main parameter is a parameter by which a target cell population is enclosed through gating from a statistical result obtained by said parameter, and the main parameter refers to at least another dimension of the particle characteristic data that is different from the auxiliary parameter; a mapping unit for mapping the extracted cell population of interest onto a statistical result of the analysis performed according to the main parameter; and a second extraction unit for determining the target cell population by using a distribution location and an edge of the cell population of interest and by incorporating a gating on the main parameter.

According to a third aspect of the present disclosure, the present disclosure provides a flow cytometer that may include: an optical detection device for performing light irradiation on a sample, collecting optical information generated by particles of the sample that receive the light irradiation, and outputting particle characteristic data corresponding to the optical information of each particle; a data processing device for receiving and processing the particle characteristic data, where the data processing device may include the above-described automatic classification apparatus for flow cytometry multidimensional data.

### BRIEF DESCRIPTION OF THE DRAWINGS

FIG. 1 is a schematic diagram of a flow cytometer;

FIG. 2 is a flow diagram for processing characteristic data of particles;

FIG. 3 is a flow diagram of extracting a cell population of interest;

FIG. 4 is a flow diagram of determining a target cell population using a distribution location and an edge of a cell population of interest;

FIG. 5 is a structure diagram of an automatic classification apparatus for flow cytometry multidimensional data;

FIGS. 6a to 6k are schematic diagrams showing processing results of a multidimensional data classification method;

FIG. 7 is a schematic diagram showing a processing result of extracting a cell population of interest;

FIG. 8 is a schematic diagram showing a processing result of extracting a cell population of interest;

FIG. 9a is a schematic diagram showing a processing result of extracting a cell population of interest;

FIG. 9b is a schematic diagram showing a gating processing result based on a multidimensional data automatic classification method.

### DESCRIPTION OF THE EMBODIMENTS

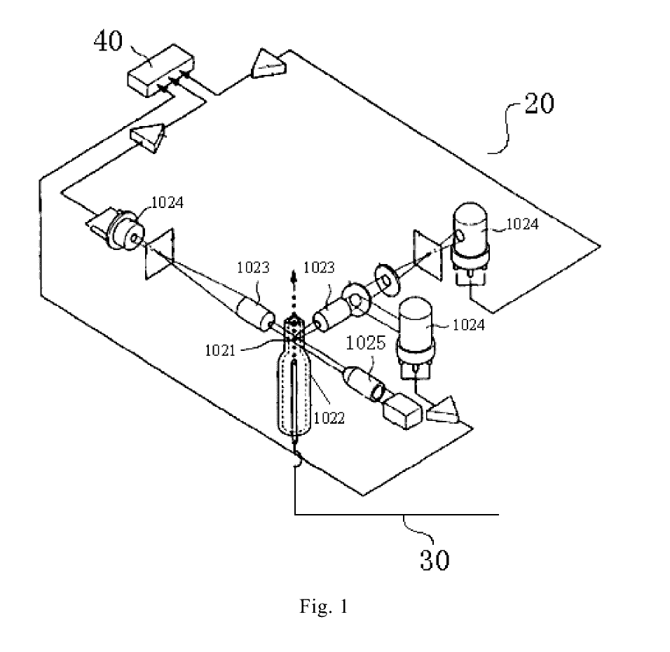

An embodiment of the present disclosure may provide a flow cytometer. Referring to FIG. 1, it is a schematic diagram for the flow cytometer, where the flow cytometer may include an optical detection device 20, a conveyor device 30, and a data processing device 40.

The conveyor device 30 may be used to convey liquid sample to the optical detection device 20. The conveyor device 30 may typically include a conveyor line and a control valve, and the liquid sample may be delivered to the optical detection device 20 through the conveyor line and the control valve.

The optical detection device 20 may be used to irradiate the liquid sample flowing through a detection region of the optical detection device 20, collect, by a plurality of channels, various kinds of optical information (such as scatter light information and/or fluorescence information) generated by irradiating cells (cells are very small particles, and so cells are also called particles), and convert the optical information into corresponding electrical signals. These optical information correspond to the characteristics of the particles and become particle characteristic data. That is, each cell particle is characterized by a multi-dimension set of parameter values, which set can be represented as an array. For example, a particle A may be represented by an array A (A1, A2, . . . , Ai). In particular, the optical detection device 20 may include a light source 1025, a flow cell 1022 as the detection region, a light collecting apparatus 1023 and a photoelectric sensor 1024 disposed on an optical axis and/or by the side of an optical axis. The liquid sample may be enveloped in the stream of a sheath liquid to pass through the flow cell 1022 that is provided as the detection zone; light beam emitted by the light source 1025 may be irradiated to the detection zone 1021; each cell particle in the liquid sample irradiated by the light beam may emit scatter light (or scatter light and fluorescence); the light collecting apparatus 1023 may collect and shape the scatter light (or the scatter light and fluorescence), and the collected light can be irradiated to the photoelectric sensor 1024 which may convert optical signal(s) into the corresponding electrical signals to output.

The data processing device 40 may perform analysis and processing on the received characteristic data of the particles.

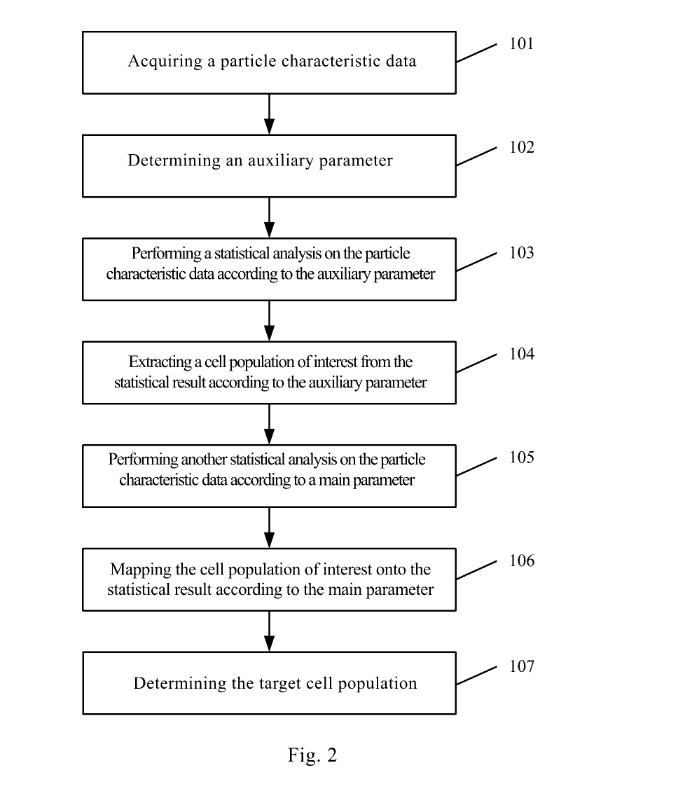

Referring to FIG. 2, FIG. 2 is a flow diagram for processing particle characteristic data, which may include the following steps.

At step 101, the particle characteristic data may be acquired.

Here, the particle characteristic data can be used to characterize cell particles. The particle characteristic data may refer to a data set collected by a plurality of channels of a flow cytometer.

At step 102, an auxiliary parameter may be determined.

The auxiliary parameter is defined relative to a main parameter. The main parameter may refer to a parameter by which a target cell population is enclosed through gating, where the main parameter may be usually determined according to a test item. A statistical analysis may be performed on the particle characteristic data according to a selected parameter to generate a histogram or a dot plot, for example, and the target cell population may be determined by the gating in a statistical result of the statistical analysis, where the selected parameter can be the main parameter of the target cell population. The auxiliary parameter may refer to a parameter that can assist the main parameter to locate the target cell population or distinguish interference cell populations. The auxiliary parameter can be selected according to an antibody and experience used in the test item. For example, a comparison table can be pre-determined between the test item and the auxiliary parameter. In an embodiment, the auxiliary parameter may be determined by table look-up according to the test item.

To highlight the role of the auxiliary parameter, a parameter in which target cells or the interference cells may have specific expression may be selected as the auxiliary parameter. For instance, corresponding parameter values of the target cells or the interference cells in a certain parameter are significantly different with or of distinct characteristic relative to those of other cells in the same parameter.

Each main parameter refers to one dimension of the particle characteristic data, and each auxiliary parameter refers to another dimension of the particle characteristic data, which dimension is different from the main parameter.

The auxiliary parameter can be one or more, which can be determined according to the test item.

At step 103, a statistical analysis may be performed on the particle characteristic data according to the auxiliary parameter.

In an embodiment, the statistical analysis may be performed on the particle characteristic data according to a single auxiliary parameter. For example, when the auxiliary parameter refers to n^{th} dimension of A1, A2, . . . , Ai, the statistical analysis is performed on the n^{th}-dimensional data A (An) of all cell particles to form a one-dimensional statistical chart such as the histogram. In another embodiment, the statistical analysis may be performed on the particle characteristic data according to a combination of the auxiliary parameter and one or more other parameter(s), or according to a combination of the plurality of auxiliary parameters. For example, when performing the statistical analysis on the data in both the n^{th} dimension and a first dimension in combination, the statistical analysis is performed on the first and n^{th}-dimensional data A (A1, An) of all cell particles to form a two-dimensional statistical chart such as the dot plot.

At step 104, a cell population of interest may be extracted from a statistical result according to the auxiliary parameter.

Here, the cell population of interest may be extracted from the statistical result according to the auxiliary parameter according to the test item and a specificity of the target cell population or interference cell population(s) on the auxiliary parameter. The cell population of interest can be used to assist in locating a location and an edge of the target cell population. The cell population of interest may be the final target cell population or a portion of the target cell population, or may be the interference cells. Since the specificity of the cell population of interest on the auxiliary parameter has been taken into account in the selection of the auxiliary parameter, it is possible to first classify some cell populations in the statistics result according to the auxiliary parameter, and then the cell population meeting the specificity may be determined as the cell population of interest based on the test item and a distribution feature of the cell population of interest on the auxiliary parameter. For example, the cell population of which an auxiliary parameter value is the largest, smallest, or within a preset range may be determined as the cell population of interest.

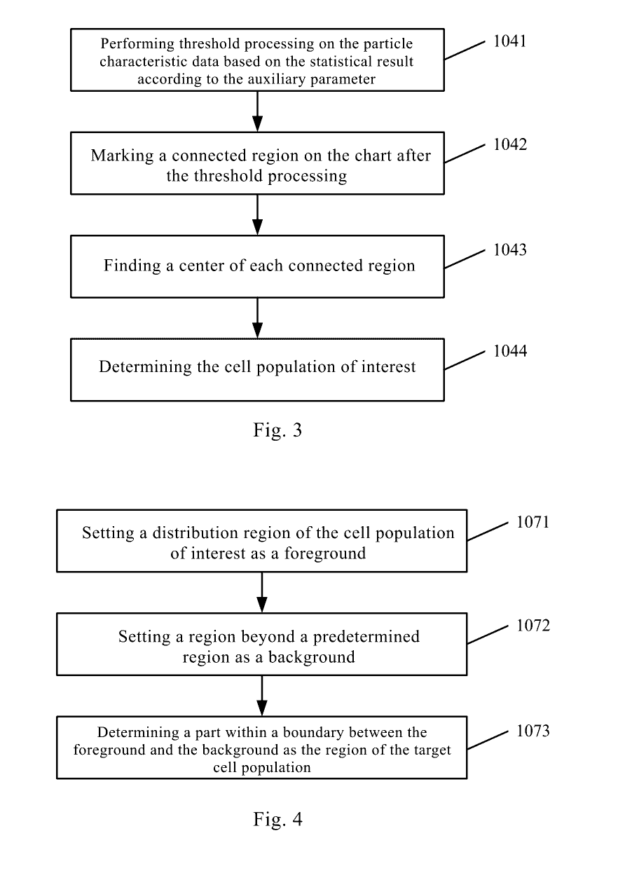

In an embodiment, the cell population of interest may be extracted as shown in FIG. 3, which may include the steps below. At step 1041, a threshold processing may be performed on the particle characteristic data based on a statistical chart of the analysis performed according to the auxiliary parameter. The threshold processing may be used to remove from the chart one or more points whose gray value is less than a threshold value, so as to remove the interference. The statistical chart may be converted into a binary image through the threshold processing to facilitate subsequent processing.

At step 1042, a connected region may be marked on the chart after the threshold processing, and the cells within one marked connected region may be deemed as a cell population.

At step 1043, a center of each connected region may be determined, and an auxiliary parameter value at the center of each connected region can be used as the auxiliary parameter value of the cell population.

At step 1044, the cell population of interest may be determined, where the cell population having the specific expression may be determined as the cell population of interest according to the distribution feature of the cell population of interest on the auxiliary parameter and the auxiliary parameter value of each cell population.

At step 105, another statistical analysis may be performed on the particle characteristic data according to the main parameter.

When the statistical analysis is performed on the particle characteristic data of all cell particles according to the main parameter, the statistical analysis can be performed according to a single main parameter to form a histogram, or the statistical analysis may also be performed by combining the main parameter with other parameter(s) to form a two-dimensional or multi-dimensional dot plot.

At step 106, the cell population of interest may be mapped onto a statistical result according to the main parameter. The cell particles belonging to the cell population of interest may be marked in the statistical result according to the main parameter. Each of the cell populations of interest may be respectively mapped onto the statistical result according to the main parameter when there are several cell populations of interest.

At step 107, the target cell population may be determined, where the target cell population may be determined by using a distribution location and an edge of the cell population of interest and by incorporating the gating on the main parameter.

Boundary of the target cell population relative to other cells can be obtained using watershed algorithm, clustering algorithm, contour method and/or gradient method, such that the target cell populations can be obtained through the gating. In an embodiment, as shown in FIG. 4, the statistical result according to the main parameter is a dot plot, and the cell population of interest is part of the target cell population, where determining the target cell population using the distribution location and the edge of the cell population of interest may include the steps below.

At step 1071, a distribution region of the cell population of interest may be used as a foreground.

At step 1072, a region beyond a foreground-setting region may be used as a background.

At step 1073, region division may be performed on the foreground and the background to find the boundary between the foreground and the background, and the region within the boundary may be determined as the distribution region of the target cell population. Here, the method for performing the region division on the foreground and the background may include watershed algorithm, active contour algorithm, or random walk algorithm.

In an embodiment, after finding the boundary between the foreground and the background, the method may further include performing a polygonal approximation processing on the boundary to obtain a polygonal gate, and the cells within the gate may be determined as the target cell population.

In the present embodiment, the above-described step 105 may also be performed before the auxiliary parameter or in synchronization with the auxiliary parameter.

In an embodiment of the present disclosure, the auxiliary parameter and the main parameter of the target cell population of each test item are selected, the particle characteristic data of the cells is statistically calculated based on the auxiliary parameter and the main parameter respectively, the cell population of interest is obtained from the statistical result according to the auxiliary parameter, the cell population of interest is then mapped to the statistical result according to the main parameter, and the target cell population is finally by using the distribution location and the edge of the cell population of interest and by incorporating the gating on the main parameter.

Depending on the selected auxiliary parameter and the cell population of interest, the cell population of interest may be part of the target cell population in some case, and thus the distribution of the cell population of interest in the statistical result according to the main parameter may provide a reference value for determining the location and the edge of the target cell population. As in the above embodiment, the distribution location and the edge of the target cell population can be determined according to the distribution location and the edge of the cell population of interest. In some other case, the cell population of interest may be the interference cells relative to the target cell population. In this situation, when a candidate target cell population is obtained through the gating in the statistical result according to the main parameter, the cell population of interest may be removed from the candidate target cell population based on the distribution of the cell population of interest in the statistical result according to the main parameter, so as to obtain the target cell population.

Embodiments of the present disclosure, on the one hand, utilize multidimensional parameters for cell analysis and thus take full advantages of the computer in multi-parameter analysis. On the other hand, the embodiments of the present disclosure have taken full account of the actual clinical values of the parameters in the test item, and thus a breakthrough is obtained, according to purpose and functions of fluorescence labeled corresponding to each parameter, in a typical analysis method from a large group (such as lymphocytes) to a subset (such as a lymphoid subset). Instead, the analysis is performed by first identifying the subset or the interference cells from the large group and then determining the large group by the assistance of the subset or the interference cells. In this way, the location and a distribution edge of the target cell population can be determined through a reversed gating to determine the location of the target cell population more accurately; also, the interference cells can be distinguished from the target cell population to improve the accuracy of cell classification. Embodiments of the present disclosure may be particularly effective when the cell populations are distributed to overlap with each other or the target cell population cannot be easily determined.

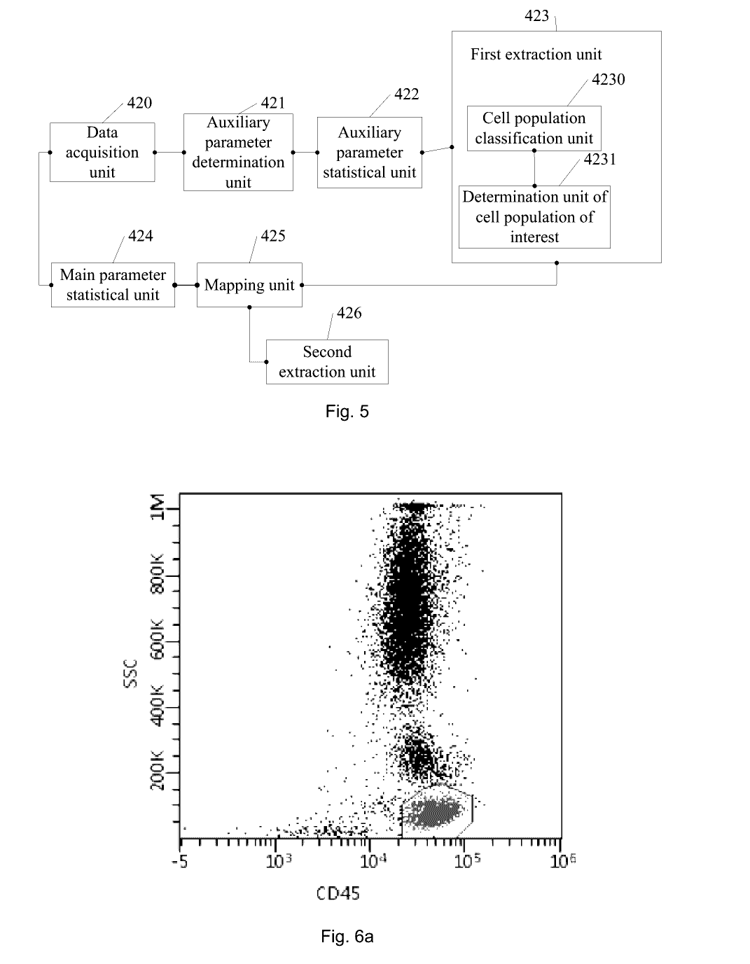

Based on the above-described method, the data processing device 40 may include an automatic classification apparatus for flow cytometry multidimensional data. As shown in FIG. 5, the automatic classification apparatus for flow cytometry multidimensional data may include a data acquisition unit 420, an auxiliary parameter determination unit 421, an auxiliary parameter statistical unit 422, a first extraction unit 423, a main parameter statistical unit 424, a mapping unit 425 and a second extraction unit 426.

The data acquisition unit 420 may be used to acquire particle characteristic data for characterizing cell particles, where the particle characteristic data is a data set collected by a plurality of channels of a flow cytometer. The auxiliary parameter determination unit 421 may be used to determine at least one auxiliary parameter according to a test item, where each auxiliary parameter may refer to one dimension of the particle characteristic data. The auxiliary parameter statistical unit 422 may be used to perform a statistical analysis on the particle characteristic data according to the auxiliary parameter. The first extraction unit 423 may be used to extract a cell population of interest from a statistical result of the statistical analysis according to the auxiliary parameter. The main parameter counting unit 424 may be used to perform another statistical analysis on the particle characteristic data according to a main parameter, where the main parameter may refer to a parameter by which a target cell population is enclosed through gating from a statistical result according to said parameter, and the main parameter may refer to another dimension of the particle characteristic data that is different from the auxiliary parameter. The mapping unit 425 may be used to map the extracted cell population of interest onto the statistical result according to the main parameter. The second extraction unit 426 may be used to determine the target cell population by using a distribution location and an edge of the cell population of interest and by incorporating the gating on the main parameter.

Performing the statistical analysis on the particle characteristic data according to the auxiliary parameter may include any one of the following:

performing the statistical analysis according to a single auxiliary parameter;

performing the statistical analysis according to a combination of the auxiliary parameter and other parameters;

performing the statistical analysis according to a combination of multiple auxiliary parameters.

In an embodiment, the auxiliary parameter determination unit 421 may determine the auxiliary parameter by table look-up according to the test item.

In an embodiment, the first extraction unit 423 may extract the cell population of interest from the statistical result according to the auxiliary parameter according to the test item and a feature of the target cell population or interference cell population(s) on the auxiliary parameter.

In an embodiment, the first extraction unit 423 may include a cell population classification subunit 4230 and a determining subunit of cell population of interest 4231.

The cell population classification subunit 4230 may be used to classify cell populations from the statistical result according to the auxiliary parameter. In an embodiment, the cell population classification subunit 4230 may be used for performing a threshold processing on the particle characteristic data based on a statistical chart of the analysis performed according to the auxiliary parameter, and for marking a connected region on the chart after the threshold processing, where the cells within one marked region may be determined as a cell population. The cell population classification subunit 4230 may also be used to determine a centre of each connected region, and to use an auxiliary parameter value at the center of each connected region as the auxiliary parameter value of each cell population. The determination subunit of cell population of interest 4231 may be used to determine the cell population of which the auxiliary parameter value is the largest, smallest, or within a preset range as the cell population of interest.

In an embodiment, the cell population of interest may belong to a portion of the target cell population, and the statistical result according to the main parameter may be a dot plot. When determining the target cell population through the distribution location and the edge of the cell population of interest, the second extraction unit 426 may set a distribution region of the cell population of interest as a foreground, set a region beyond a foreground-setting region in the dot plot as a background, perform region division on the foreground and the background to find a boundary between the foreground and the background, and determine the region within the boundary as a distribution region of the target cell population. In a further embodiment, after determining the boundary between the foreground and the background, the second extraction unit 426 may further perform a polygonal approximation processing on the boundary to obtain a polygonal gate, and the cells within the gate can be determined as the target cell population.

Below the enclosing of lymphocytes by virtue of gating in a peripheral blood lymphocyte subset test item is used as an example for further description.

Lymphocyte subset is an important indicator for the immune function detection, and it is mainly used for diagnosis and clinical treatment of immune system diseases and immune-related diseases. Monoclonal antibodies for detecting the lymphocyte subset may include antibodies of CD45, CD3, CD4, CD8, CD19, CD16 and CD56. Therefore, in the lymphocyte subset test item, test data may usually include forward scatter light, side scatter light and fluorescents from multiple channels including the CD45 channel, CD3 channel, CD4 channel, CD8 channel, CD19 channel, CD16 channel and CD56 channel CD45 is expressed in all leukocytes; CD3 is expressed in T lymphocytes; CD4 is expressed in T helper lymphocytes (CD4+T cells) and monocytes; CD8 is expressed in cytotoxic T cells (CD8+T cells) and NK cells; CD19 is expressed in B lymphocytes; CD16 is expressed in NK cells, mononuclear macrophages, granulocytes and dendritic cells; and CD56 is expressed in NK cells and cytotoxic T cells.

The antibody of CD45 is usually used as the antibody for gating to first identify the lymphocytes, and then the lymphocytes can be classified according to specific expressions of CD3, CD4, CD8, CD19, CD16 and CD56 in each lymphoid subset.

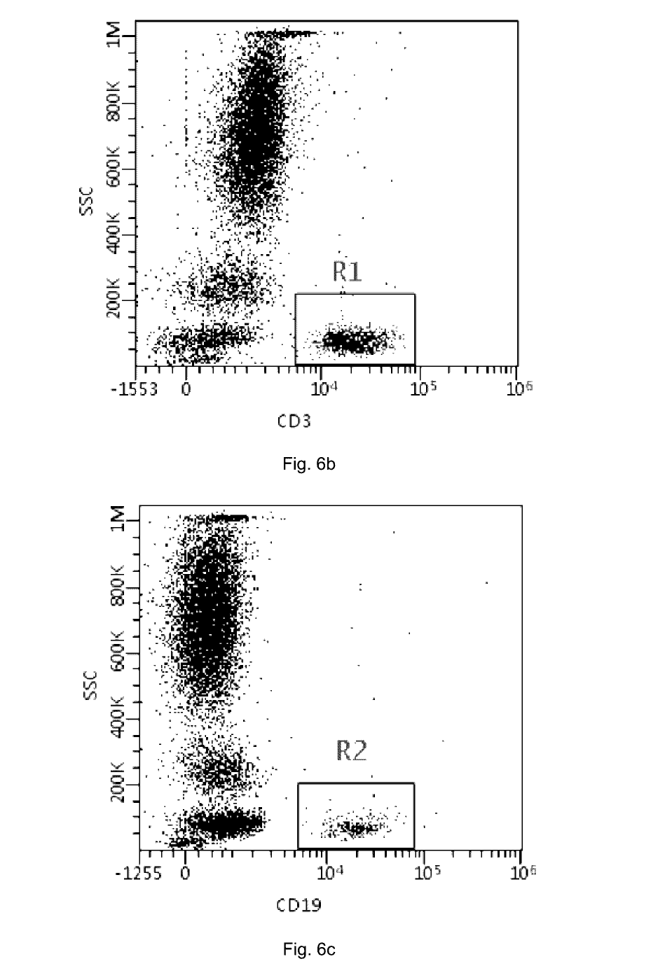

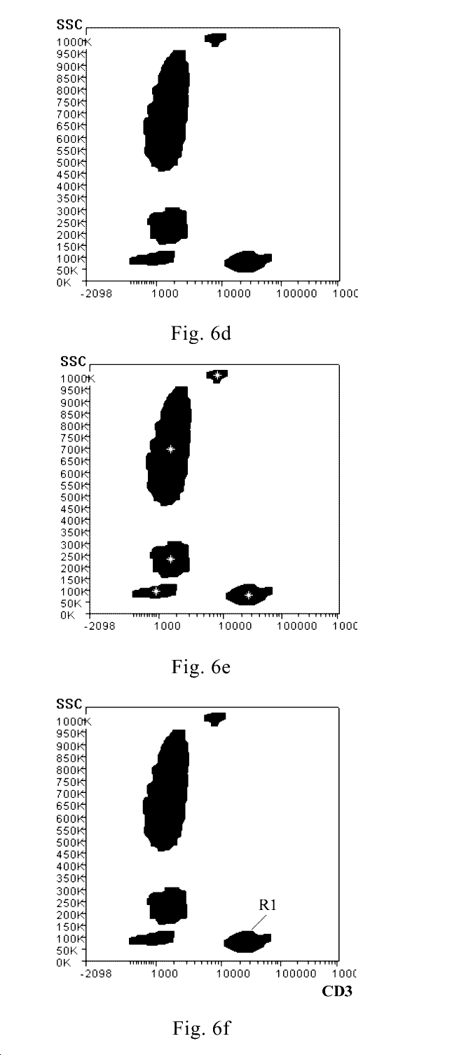

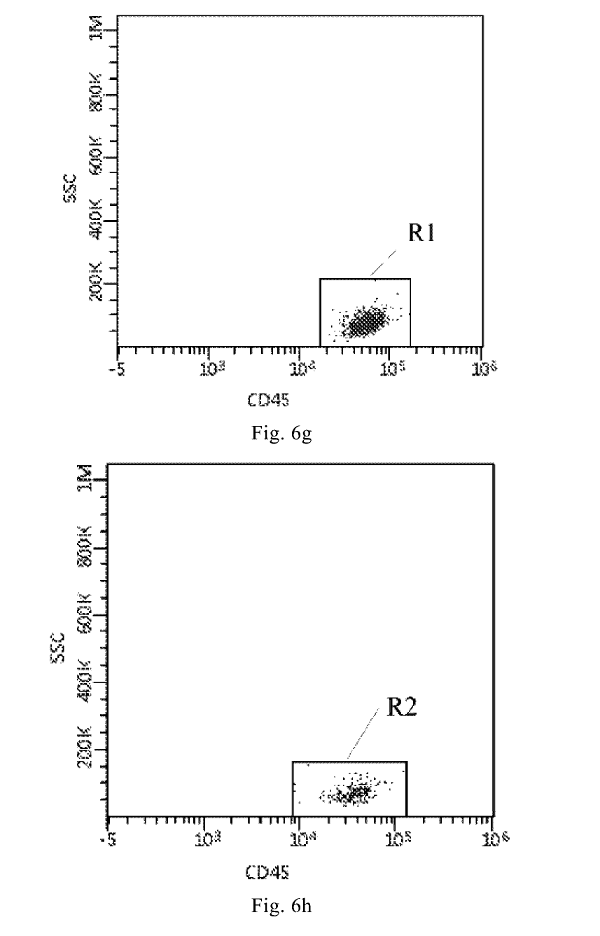

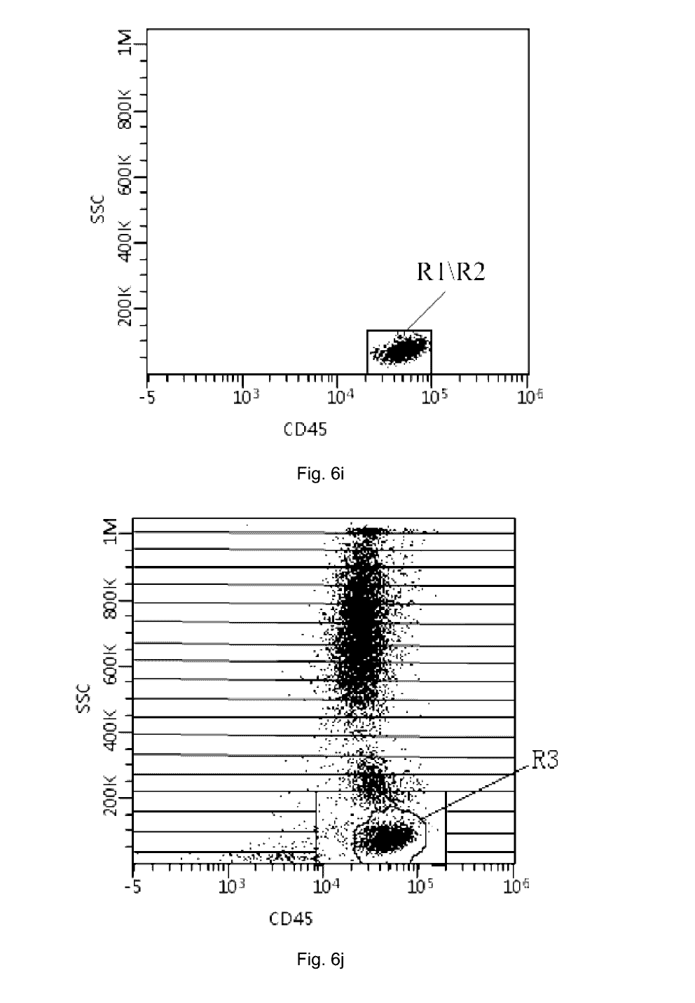

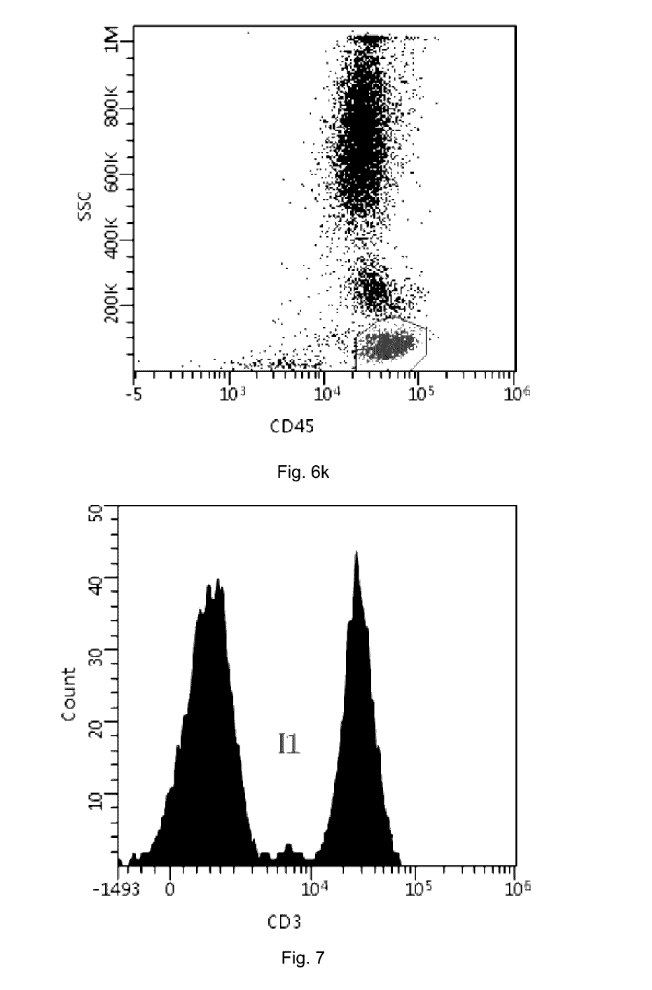

The main parameters for the gating in the lymphocyte detection are SSC and CD45. FIG. 6a is an SSC/CD45 dot plot, where a polygon here represents the gating and the part enclosed by the polygon may refer to the lymphocytes. However, when there are a large number of abnormal lymphocytes, immature cells, nucleated red blood cells, basophils and monocytes or when abnormal lymphocyte(s), immature cell(s), nucleated red blood cell(s), basophil(s) and monocyte(s) are close to the lymphocyte population, they may interferes the gating for the lymphocytes. Also, the location of each cell population in the dot plot may deviate from its expected location due to changes in instrument settings such as voltage or compensation, changes in antibody concentration in a reagent, abnormal blood samples, or errors in sample preparation operations. At this point, it may be inaccurate to determine the lymphocytes only by the gating on the main parameters of SSC and CD45, so that the lymphocyte subset analysis based on the determined lymphocytes may also be inaccurate. In this situation, the present disclosure notes that the antibodies of CD3, CD4, CD8, CD19, CD16 and CD56 etc. are useful for identifying the lymphocytes. However, since they are not specific markers for the lymphocytes, a cluster analysis of the lymphocytes cannot be directly performed utilizing these antibodies. Therefore, according to the characteristics of the fluorescence parameters of the labeled cells, the cell population may be classified using other fluorescence parameters in the embodiment of the present disclosure, where it is easier to identify the cell population using these fluorescence parameters. Then, the cell population can be determined, by the gating, on the target dot plot for further analysis according to the classified cell populations. Such method may include the following steps.

At step S1, the auxiliary parameter may be determined.

The auxiliary parameter for the gating, e.g., the CD3 and the CD19 in this embodiment, can be used to separate the target cell population and the interference cell populations. Strongly positive fluorescence can be respectively obtained in the CD3 channel or the CD19 channel for the lymphocytes that contain the CD3 or the CD19 respectively, and thus the lymphocytes that contain the CD3 or the CD19 can be clearly separated from other adjacent cells. For this reason, both the CD3 and CD19 can be selected as the auxiliary parameter. CD3 is expressed in T lymphocytes, and CD19 is expressed in B lymphocytes.

At step S2, a statistical analysis may be performed on the particle characteristic data according to the auxiliary parameter, and the cell population of interest may be extracted.

FIGS. 6b and 6c are statistical results when the statistical analysis is performed on the particle characteristic data according to the combination of the auxiliary parameter and another parameter. FIG. 6b is a statistical result when combing the CD3 with the SSC, and FIG. 6c is a statistical result when combining the CD19 with the SSC.

As shown in FIG. 6b, a region marked as R1 is a T lymphocyte subset, which is the cell population of interest. As shown in FIG. 6c, a region marked as R2 is a B lymphocyte subset, which is also the cell population of interest.

The region R1 may be automatically extracted in the SSC/CD3 dot plot in FIG. 6 as follow.

1) The SSC/CD3 dot plot may be smoothened by, for example, a linear or nonlinear smoothing filter using Gaussian smoothing, mean filtering or median filter.

2) Threshold processing may be performed on the dot plot to obtain FIG. 6d. The threshold processing may be used to remove from the plot one or more pixels whose gray value is/are less than a threshold value. Provided that the original plot is set as I(x, y) ((x, y) represents coordinates of a pixel), and the processed plot may be set as Iₜₕᵣₑₛₕ(x, y),

where:

$${I}_{thresh} ( x , y ) = \{ \begin{matrix}I ( x , y ) , & if I ( x , y ) > threshold \\ 0 , & else\end{matrix} .$$

3) One or more connected regions may be marked on the plot after the threshold processing.

The connected region(s) is/are marked on FIG. 6d, and a center of each connected region is then determined. For example, each position indicated by “*” in FIG. 6e is the centre of each connected region.

In this embodiment, blob analysis method can be used to extract the center of each connected region, which is equivalent to extract location information. Similarly, size, shape, direction, quantity and other information of the connected region can also be used to detect the center of the connected region.

4) The center of each connected region can be compared, and the region with the largest center in a CD3 direction may be selected as a first cell population of interest R1, such as the region R1 in FIG. 6f.

5) For the SSC/CD19 dot plot, a second auxiliary cell population of interest, i.e., the region marked as R2 in FIG. 6c, is obtained using the same method.

6) Another statistical analysis is performed on the particle characteristic data according to the main parameter, and the cell populations of interest are mapped onto the statistical result according to the main parameter.

In this embodiment, the peripheral blood lymphocyte subset is detected using the SSC and the CD45 as the main parameters. The extracted cell populations of interest R1 and R2 are respectively mapped onto the statistical chart of the analysis performed according to the main parameters of SSC and CD45, where the mapping is shown in FIG. 6g and FIG. 6h, respectively.

The cell populations of interest in this embodiment are only a portion of the lymphocytes. However, mapping the cell populations of interest onto the SSC/CD45 dot plot can indicate the distribution location and the edge of the lymphocytes.

7) The target cell population may be determined using the auxiliary cell populations and combining with the gating on the main parameter.

In this embodiment, watershed algorithm is used. In the SSC/CD45 dot plot, the cell population of interest is one determined region, and a distribution region of the cell population of interest is marked as a foreground as shown in FIG. 6i. The region of which a distance from a circumscribed rectangle of the marked region in FIG. 6i is greater than r is marked as a background (e.g., a horizontal line area shown in FIG. 6j), where the r is a preset value. It can be understood by those skilled person in the art that the circumscribed rectangle is not necessary here, while geometrical figures of other shapes may alternatively be used. The watershed algorithm is then used to find a boundary between the foreground and the background, and the region within the boundary is determined as a distribution region of the target cell population. For example, a region R3 enclosed by a curve in FIG. 6j is the region of the target cell population.

In this embodiment, the watershed algorithm is used for the region division between the foreground and background. In another embodiment, active contour algorithm or random walk algorithm can also be used to perform the region division on the foreground and background.

In this embodiment, polygonal approximation processing can be performed on the region R3 in FIG. 6j to obtain a polygonal gate, i.e., the polygon gate in FIG. 6k (an enclosed area in the figure).

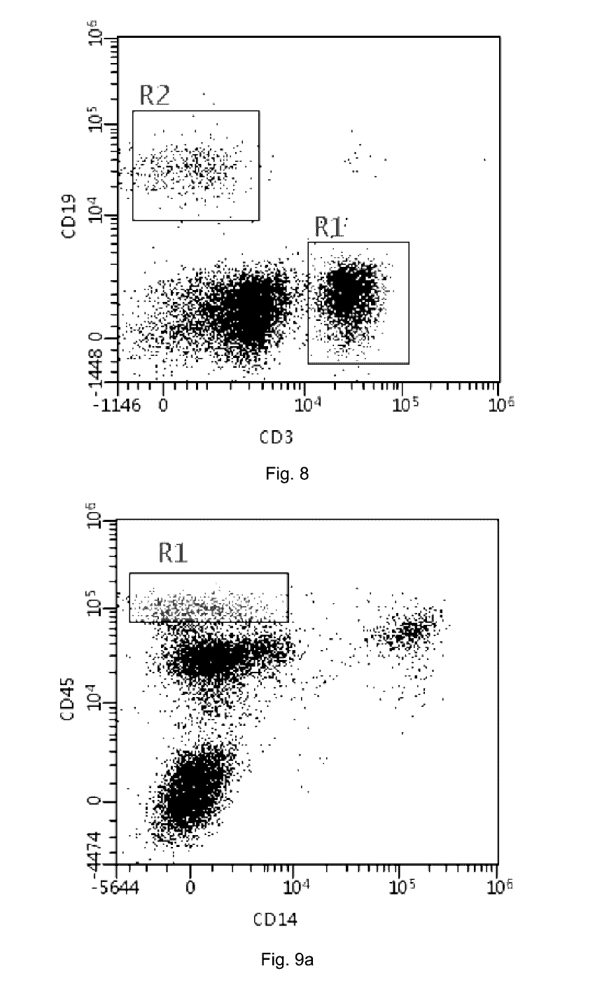

The above-described embodiment has been described in detail the case where the auxiliary parameter is used in combination with other parameters, such as the SSC in the above embodiment. It can be understood by those skilled person in the art that the auxiliary parameter may also be used alone. For example, as shown in FIG. 7, histograms of the CD3 and the CD19 can be processed respectively, and I1 is the extracted cell population of interest. It is also possible to process each auxiliary parameter separately; for instance, the SSC/CD3 dot plot and the SSC/CD19 dot plot are respectively processed in the above-described embodiment. Alternatively, the auxiliary parameters can be processed in combination; for instance, a CD3/CD19 dot plot is processed, and the cell populations enclosed by R1 and R2 as shown in FIG. 8 are the extracted cell populations of interest.

Examples of such automatic classification using multidimensional data may be applied to a two-color, three-color, four-color and six-color antibody combinations of the lymphocyte subset.

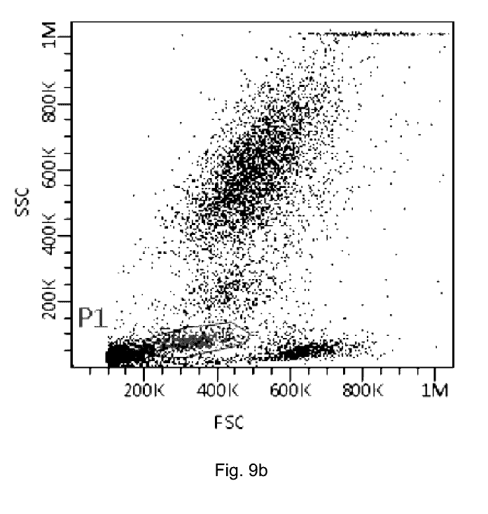

In the lymphocyte subset analysis using the two-color antibody combination, a lymphocyte gate is set on an FSC/SSC dot plot, where the FSC and the SSC are the main parameters for the gating. The lymphocyte population and other surrounding cell populations locate closely or overlap with each other. In order to make the lymphocyte gate more reliable, CD14 and CD45 can be used as the auxiliary parameter to assist the gating. The lymphocytes that contain the CD45 and the CD14 are strongly positive in the CD45 channel and negative in the CD14 channel. Thus, as shown in FIG. 9a, an upper-left region of the dot plot, which refers to the region enclosed by R1, is determined as the auxiliary cell population of interest. Then the auxiliary cell population of interest is mapped onto the SSC/FSC dot plot, and is further marked thereon using different colors, for example. Automatic gating may further be performed on the SSC/FSC dot plot according to the distribution of marked scatters, where one gate is shown as a P1 gate in FIG. 9b.

In a leukemia immunophenotyping analysis, it is needed to classify nucleated cells on a CD45/SSC dot plot, and thus the main parameters are the SSC and the CD45. For example, immature cells of a patient with acute B lymphoblastic leukemia often appear in the position of nucleated red blood cells. In this case, CD19, CD34 and CD10 can be used as the auxiliary parameters for the gating, and the cells which are all positive in these three parameters CD19, CD34 and CD10 are extracted to be mapped onto the CD45/SSC dot plot. In this way, it can determine the location of the immature cells, and an immature cell population can then be enclosed using the corresponding algorithm.

For normal bone marrow samples of a patient having multiple myeloma, it is needed to perform gating on plasma cells on the CD45/SSC dot plot. The plasma cells may locate close to or overlap with the position of nucleated red blood cells or immature cells. In this case, CD38 (or CD138) can be used as the auxiliary parameter, and the cells which have strong expression in the CD38 (or the CD138) are the plasma cells. Those cells are mapped onto the CD45/SSC dot plot, and a plasma cell population can then be enclosed using the corresponding algorithm. The plasma cell population contains plasma cells that express the CD38 (or the CD138) and plasma cells that do not express the CD38 (or the CD138).

The auxiliary parameter can be used not only to indicate the target cells, but also to exclude the interference cells. When using the auxiliary parameter to exclude the interference cells, the auxiliary cell population of interest extracted from the statistical result according to the auxiliary parameter definitely does not belong to the target cell population. After the target cell population is determined using other methods in the main parameter for the gating, the auxiliary cell population of interest may also be mapped onto the statistical result according to the main parameter, where the auxiliary cell population can verify whether the target cell population is selected correctly. When it is verified to be incorrect, some further processing may be performed subsequently; for example, the cells to be excluded can be removed from the target cell population, or a prompt may be outputted to ask a user to review the result.

It can be understood by those skilled persons in the art that all or part of the steps of the various methods of the above-described embodiments may be performed by programs of a computer by instructing related hardware. The programs can be stored in a computer readable storage medium. The storage medium may be disk, CD, ROM (Read-Only Memory) or RAM (Random Access Memory), etc.

The foregoing uses examples to explain the present disclosure. However, these examples are only used to help in understanding the present disclosure, rather than limiting the present disclosure. Modifications can be made to the above-described specific implementations by those ordinary skilled persons in the art according to the concept of the present disclosure.

1. An automatic classification method for flow cytometry multidimensional data, comprising:
acquiring particle characteristic data for characterizing cell particles, wherein the particle characteristic data is a data set collected by a plurality of channels of a flow cytometer;
determining at least one auxiliary parameter according to a test item of the flow cytometer, wherein each auxiliary parameter refers to one dimension of the particle characteristic data;
performing a statistical analysis on the particle characteristic data according to the auxiliary parameter;
extracting a cell population of interest from a statistical result of the analysis performed according to the auxiliary parameter;
performing another statistical analysis on the particle characteristic data according to a main parameter, wherein the main parameter refers to a parameter by which a target cell population is enclosed through gating from a statistical result obtained by said parameter, and the main parameter refers to at least another dimension of the particle characteristic data that is different from the auxiliary parameter;
mapping the extracted cell population of interest onto a statistical result of the analysis performed according to the main parameter; and
determining the target cell population by using a distribution location and an edge of the cell population of interest and by incorporating a gating on the main parameter.

2. The method of claim 1, wherein performing the statistical analysis on the particle characteristic data according to the auxiliary parameter comprises one of the following:
performing the statistical analysis according to a single auxiliary parameter;
performing the statistical analysis according to a combination of the auxiliary parameter and one or more other parameters;
performing the statistical analysis according to a combination of multiple auxiliary parameters.

3. The method of claim 1, wherein the auxiliary parameter is determined by table look-up according to the test item.

4. The method of claim 1, wherein the cell population of interest is extracted from the statistical result of the analysis performed according to the auxiliary parameter based on the test item and a specificity of the target cell population or interference cell populations on the auxiliary parameter.

5. The method of claim 4, wherein extracting the cell population of interest from the statistical result of the analysis performed according to the auxiliary parameter comprises:
classifying cell populations from the statistical result of the analysis performed according to the auxiliary parameter; and
determining one of the cell populations of which an auxiliary parameter value is the largest, smallest, or within a preset range as the cell population of interest.

6. The method of claim 5, wherein classifying the cell populations from the statistical result of the analysis performed according to the auxiliary parameter comprises:
performing a threshold processing on the particle characteristic data according to a statistical chart of the analysis performed according to the auxiliary parameter;
marking a connected region on the chart after the threshold processing; and
determining cells within one marked region as a cell population.

7. The method of claim 6, further comprising:
determining a center of each connected region; and
setting an auxiliary parameter value at the center of each connected region as the auxiliary parameter value of each cell population.

8. The method of claim 1, wherein the statistical result of the analysis performed according to the main parameter is a dot plot, and determining the target cell population by using the distribution location and the edge of the cell population of interest comprises:
setting a distribution region of the cell population of interest as a foreground;
setting a region beyond a foreground-setting region in the dot plot as a background; and
performing region division on the foreground and the background to find a boundary between the foreground and the background, and determining a region within the boundary as a distribution region of the target cell population.

9. The method of claim 8, wherein the region division for the foreground and the background is performed through watershed algorithm, active contour algorithm, or random walk algorithm.

10. The method of claim 8, wherein after finding the boundary between the foreground and the background, further comprising: performing a polygonal approximation processing on the boundary to obtain a polygonal gate, and determining cells within the polygonal gate as the target cell population.

11. The method of claim 1, wherein an algorithm for determining the target cell population by using the distribution location and the edge of the cell population of interest comprises: clustering algorithm, contour method, or gradient method.

12-20. (canceled)

21. A flow cytometer, comprising:
an optical detection device for performing light irradiation on a sample, collecting optical information generated by particles of the sample that receive the light irradiation, and outputting particle characteristic data corresponding to the optical information of each particle; and
a data processing device for receiving and processing the particle characteristic data, wherein the processing device comprising one or more processors that are configured to:
acquire particle characteristic data for characterizing cell particles, wherein the particle characteristic data is a data set collected by a plurality of channels of a flow cytometer;
determine at least one auxiliary parameter according to a test item of the flow cytometer, wherein each auxiliary parameter refers to one dimension of the particle characteristic data;
perform a statistical analysis on the particle characteristic data according to the auxiliary parameter;
extract a cell population of interest from a statistical result of the analysis performed according to the auxiliary parameter;
perform another statistical analysis on the particle characteristic data according to a main parameter, wherein the main parameter refers to a parameter by which a target cell population is enclosed through gating from a statistical result obtained by said parameter, and the main parameter refers to at least another dimension of the particle characteristic data that is different from the auxiliary parameter;
map the extracted cell population of interest onto a statistical result of the analysis performed according to the main parameter; and
determine the target cell population by using a distribution location and an edge of the cell population of interest and by incorporating a gating on the main parameter.

22. The flow cytometer of claim 21, wherein the one or more processors are further configured to:
perform the statistical analysis according to a single auxiliary parameter;
perform the statistical analysis according to a combination of the auxiliary parameter and one or more other parameters;
perform the statistical analysis according to a combination of multiple auxiliary parameters.

23. The flow cytometer of claim 21, wherein the auxiliary parameter is determined by table look-up according to the test item.

24. The flow cytometer of claim 21, wherein the one or more processors are further configured to extract, based on the test item and a specificity of the target cell population or interference cell populations on the auxiliary parameter, the cell population of interest from the statistical result of the analysis performed according to the auxiliary parameter.

25. The flow cytometer of claim 24, wherein the one or more processors are further configured to:
classify cell populations from the statistical result of the analysis performed according to the auxiliary parameter; and
determine one of the cell populations of which an auxiliary parameter value is the largest, smallest, or within a preset range as the cell population of interest.

26. The flow cytometer of claim 25, wherein the one or more processors are further configured to:
perform a threshold processing on the particle characteristic data according to a statistical chart of the analysis performed according to the auxiliary parameter;
mark a connected region on the chart after the threshold processing; and
determine cells within one marked region as a cell population.

27. The flow cytometer of claim 26, wherein the one or more processors are further configured to:
determine a center of each connected region; and
set an auxiliary parameter value at the center of each connected region as the auxiliary parameter value of each cell population.

28. The flow cytometer of claim 21, wherein the statistical result of the analysis performed according to the main parameter is a dot plot, and the one or more processors are further configured to:
set a distribution region of the cell population of interest as a foreground;
set a region beyond a foreground-setting region in the dot plot as a background; and
perform region division on the foreground and the background to find a boundary between the foreground and the background, and determine a region within the boundary as a distribution region of the target cell population.

29. The flow cytometer of claim 21, wherein the one or more processors are further configured to:
perform a polygonal approximation processing on the boundary to obtain a polygonal gate, and determine cells within the polygonal gate as the target cell population after finding the boundary between the foreground and the background.
